(19) United States
(12) Patent Application Publication
(10) Pub. No.: US 2008/0160944 A1
(43) Pub. Date: Jul. 3, 2008

(54) COMMON-SPECTRUM TRANSMISSION METHOD FOR AUDIO AND VIDEO SIGNALS AND SYSTEM THEROF

(76) Inventors: Yingping Zhou, Xuchang (CN); Hui Zhou, Xuchang (CN)

Correspondence Address: SEED INTELLECTUAL PROPERTY LAW GROUP PLLC, 701 FIFTH AVE, SUITE 5400, SEATTLE, WA, 98104, US

(21) Appl. No.: 11/849,140

(22) Filed: Aug. 31, 2007

(30) Foreign Application Priority Data
Dec. 28, 2006 (CN) 200610170316.0

(51) Int. Cl. H04B 1/16

(52) U.S. Cl. 455/207

(57) ABSTRACT

Embodiments of the present invention relate to a common-spectrum transmission method for audio and video signals and a system thereof. The method comprises: a step A of performing a first frequency mixing process to a modulated carrier signal f0 of audio and video signals and a local oscillation signal f1 to generate a carrier signal f01; a step B of multiplexing the carrier signal f01 and the local oscillation signal f1 and then sending them to a transmitting base station; a step C of the transmitting base station performing a second frequency mixing process based on the carrier signal f01 and the local oscillation signal f1 to obtain the modulated carrier signal f0; a step D of the transmitting base station sending the modulated carrier signal f0 to respective receiving terminals. Since the reference local oscillation signal f1 used by the respective transmitting base stations at the time of performing the frequency mixing comes from one same local oscillation signal source and reaches the frequency mixing unit synchronously with the carrier signal f01, the spectrums of the modulated carrier signal f0 generated by restoration at respective base stations are completely uniform and the common frequency interference generated by respective base stations in the coherent zone can be reduced to minimum.

### CROSS REFERENCE TO RELATED APPLICATION

The present application is related to and claims priority to Chinese Patent Application No. 200610170316.0, entitled “COMMON-SPECTRUM TRANSMISSION METHOD FOR AUDIO AND VIDEO SIGNALS AND A SYSTEM THEREOF,” filed on Dec. 28, 2006. The application is hereby incorporated by reference in its entirety.

### TECHNICAL FIELD

The present disclosure generally relates to the field of communication. In particular but not exclusively, the present disclosure relates to a common-spectrum transmission method for audio and video signals and a system thereof.

### BACKGROUND INFORMATION

In order to realize a large-area coverage of audio and video signals, such as signals of digital TVs and broadcasting, conventional technologies generally use a plurality of transmitting base stations at the time of transmitting audio and video signals to transfer the signals synchronously in a common spectrum. However, the frequency, the phase and the modulation wave shape of signals from adjacent transmitting base stations are required to be completely identical in order that a synchronous receiving can be achieved in a signal intersection area between the adjacent transmitting base stations.

FIG. 1 is schematic view showing such kind of a common-spectrum and synchronous transmission system for audio and video signals. As shown in FIG. 1, conventional common-spectrum and synchronous transmission process for audio and video signals comprises the steps of: generating a link carrier signal f0 by frequency converting modulated audio and video signals, and sending the signal f0 to respective transmitting base station via carriers; restoring the generated modulated carrier signal f0 through demodulation and re-modulation and sending it at respective transmitting base stations. However, since in the above procedure the transmitting base stations use independent local oscillation signal sources respectively to realize the spectrum restoration, a time delay and a phase error exist between the spectrum wave shape of the local oscillation signal of the independent local oscillation signal source and that of a local oscillation signal source of a transmitting center, although the independent local oscillation signal source is subject to a synchronous lock by a GPS clock. Therefore, spectrum restoration signals transmitted by respective base stations can not be completely identical, and a synchronous interference is inevitably produced in a coherent zone of two base stations.

### BRIEF SUMMARY

This section is for the purpose of summarizing some aspects of the present invention and to briefly introduce some embodiments. Simplifications or omissions in this section as well as the title and the abstract of this disclosure may be made to avoid obscuring the purpose of the section, the title and the abstract. Such simplifications or omissions are not intended to limit the scope of the present invention.

One aspect of the present invention provides a common-spectrum transmission method for audio and video signals and a system thereof, which can overcome the disadvantage in the conventional art that a common frequency interference distortion is generated between adjacent transmitting base stations at the time of transferring audio and video signals in a common spectrum among a plurality of transmitting base stations.

Other aspects, features, and advantages of the present invention will become apparent upon examining the following detailed description of one or more non-limiting and non-exhaustive embodiments thereof, taken in conjunction with the attached drawings.

One embodiment of the present invention provides a common-spectrum transmission method for audio and video signals, comprising:

a step A of performing a first frequency mixing process to a modulated carrier signal f0 of audio and video signals and a local oscillation signal f1 to generate a carrier signal f01;

a step B of multiplexing the carrier signal f01 and the local oscillation signal f1 and then sending them to a transmitting base station;

a step C of the transmitting base station performing a second frequency mixing process based on the carrier signal f01 and the local oscillation signal f1 to obtain the modulated carrier signal f0;

a step D of the transmitting base station sending the modulated carrier signal f0 to respective receiving terminals.

The step B of one embodiment further comprises a step of filtering/amplifying the carrier signal f01 and the local oscillation signal f1.

The step C of one embodiment further comprises a step of filtering/amplifying the carrier signal f01 and the local oscillation signal f1.

In the step D of one embodiment, the transmitting base station filters/amplifies the modulated carrier signal f0 and then sends it to respective receiving terminals.

The audio and video signals in one embodiment are digital TV signals or broadcasting signals.

One embodiment of the present invention also provides a common-spectrum transmission system for audio and video signals, comprising a carrier signal generating unit and a plurality of transmitting base stations, wherein

the carrier signal generating unit comprises:

a modulating unit for modulating the audio and video signals as a carrier signal f0;

a local oscillation unit for generating a local oscillation signal f1;

a first frequency mixing unit for mixing the carrier signal f0 and the local oscillation signal f1 to generate a carrier signal f01; and

a multiplexing unit for multiplexing the carrier signal f01 and the local oscillation signal f1 and then sending them to the transmitting base stations, the transmitting base station comprises:

a second frequency mixing unit for performing a frequency mixing process based on the carrier signal f01 and the local oscillation signal f1 to obtain the carrier signal f0;

a transmitting unit for sending the carrier signal f0 to a receiving terminal.

The carrier signal generating unit of one embodiment further comprises a first filtering/amplifying unit for filtering/amplifying the carrier signal f01 outputted from the first frequency mixing unit and/or the local oscillation signal f1 outputted from the local oscillation unit.

The transmitting base station of one embodiment further comprises a second filtering/amplifying unit for receiving the signal sent by the carrier signal generating unit and filtering/amplifying the received signal to obtain the carrier signal f01 and/or the local oscillation signal f1.

The transmitting base station of one embodiment further comprises a third filtering/amplifying unit connected to the second frequency mixing unit for filtering/amplifying the carrier signal f0 outputted from the second frequency mixing unit and then sending it to the transmitting unit.

According to one embodiment of the present invention, since the reference local oscillation signal f1 used by the respective transmitting base stations at the time of performing the frequency mixing comes from one same local oscillation signal source and reaches the frequency mixing unit synchronously with the carrier signal f01, the spectrums of the modulated carrier signal f0 generated by restoration at respective base stations are completely uniform and the common frequency interference generated by respective base stations in the coherent zone can be reduced to minimum.

### BRIEF DESCRIPTION OF THE SEVERAL VIEWS OF THE DRAWINGS

One or more non-limiting and non-exhaustive embodiments of the invention will be readily understood by the following detailed description in conjunction with the accompanying drawings, wherein like reference numerals designate like structural elements, and in which:

FIG. 1 is a schematic view showing a structure of a conventional common-spectrum and synchronous transmission system for audio and video signals;

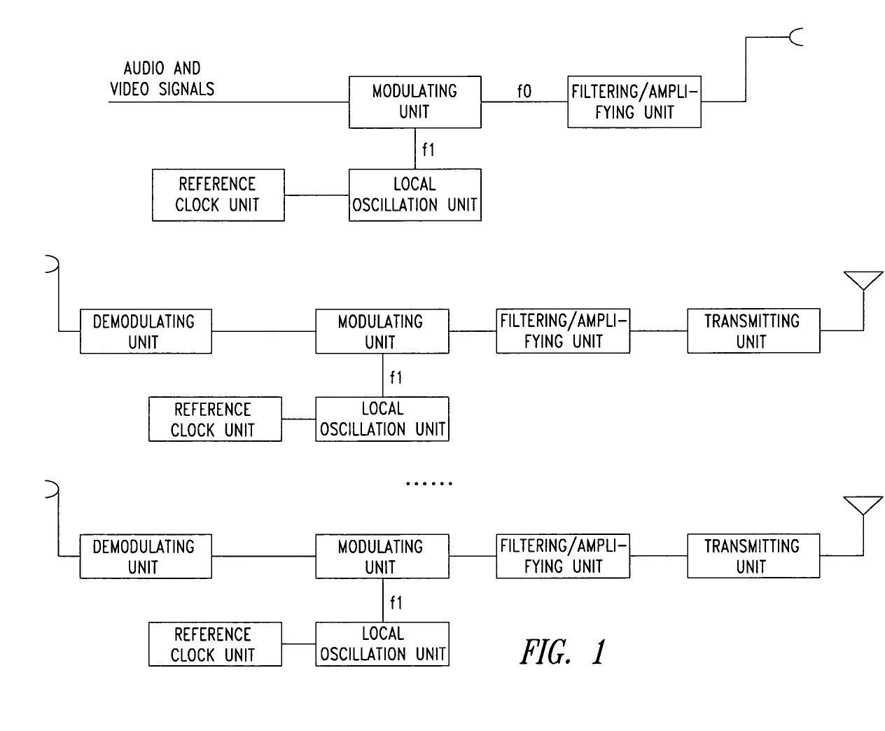

FIG. 2 is a schematic view showing a structure of a common-spectrum transmission system for audio and video signals according to one embodiment of the present invention;

FIG. 3 is a flowchart showing the common-spectrum transmission of audio and video signals according to one embodiment of the present invention.

### DETAILED DESCRIPTION

The present invention will be described in detail with reference to the example non-limiting and non-exhaustive figures and embodiments. The detailed description of various embodiments of the invention is presented largely in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth in order to provide a thorough understanding of embodiments of the present invention. However, various embodiments of the present invention may be practiced without these specific details. In other instances, well known methods, procedures, components, and circuitry have not been described in detail to avoid unnecessarily obscuring aspects of the present invention.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

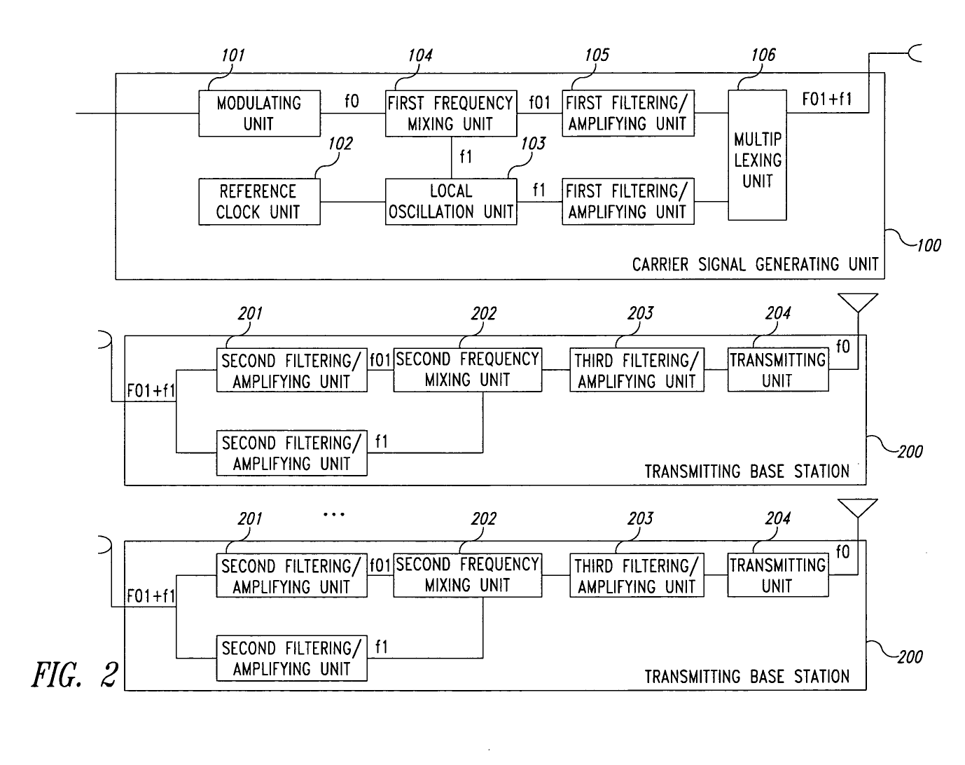

FIG. 2 is a schematic view showing a structure of a common-spectrum transmission system for audio and video signals according to one embodiment of the present invention. As shown in FIG. 2, the common-spectrum transmission system for audio and video signals comprises a carrier signal generating unit 100 and a plurality of transmitting base stations 200.

The carrier signal generating unit 100 of one embodiment comprises:

a modulating unit 101 for modulating the audio and video signals as a carrier signal f0;

a reference clock unit 102 for providing a reference clock signal;

a local oscillation unit 103 for generating a local oscillation signal f1 based on the reference clock signal provided by the reference clock unit 102;

a first frequency mixing unit 104 for receiving the carrier signal f0 sent by the modulating unit 101 and the local oscillation signal f1 sent by the local oscillation unit 103, and mixing the carrier signal f0 and the local oscillation signal f1 to generate a carrier signal f01;

a first filtering/amplifying unit 105 for filtering/amplifying the carrier signal f01 generated by the first frequency mixing unit 104 and the local oscillation signal f1 generated by the local oscillation unit 103;

a multiplexing unit 106 connected to the first filtering/amplifying unit 105 for multiplexing the carrier signal f01 and the local oscillation signal f1 and then sending them to the transmitting base stations 200.

The transmitting base station 200 of one embodiment comprises:

a second filtering/amplifying unit 201 for receiving the signal sent by the carrier signal generating unit 100 and filtering/amplifying the received signal to obtain the carrier signal f01 and the local oscillation signal f1;

a second frequency mixing unit 202 for receiving the carrier signal f01 and the local oscillation signal f1 and mixing the carrier signal f01 and the local oscillation signal f1 to obtain the carrier signal f0;

a third filtering/amplifying unit 203 for filtering/amplifying the carrier signal f0 obtained through a frequency mixing by the second frequency mixing unit 202 and then sending it to a transmitting unit 204 which sends the carrier signal f0 to a receiving terminal.

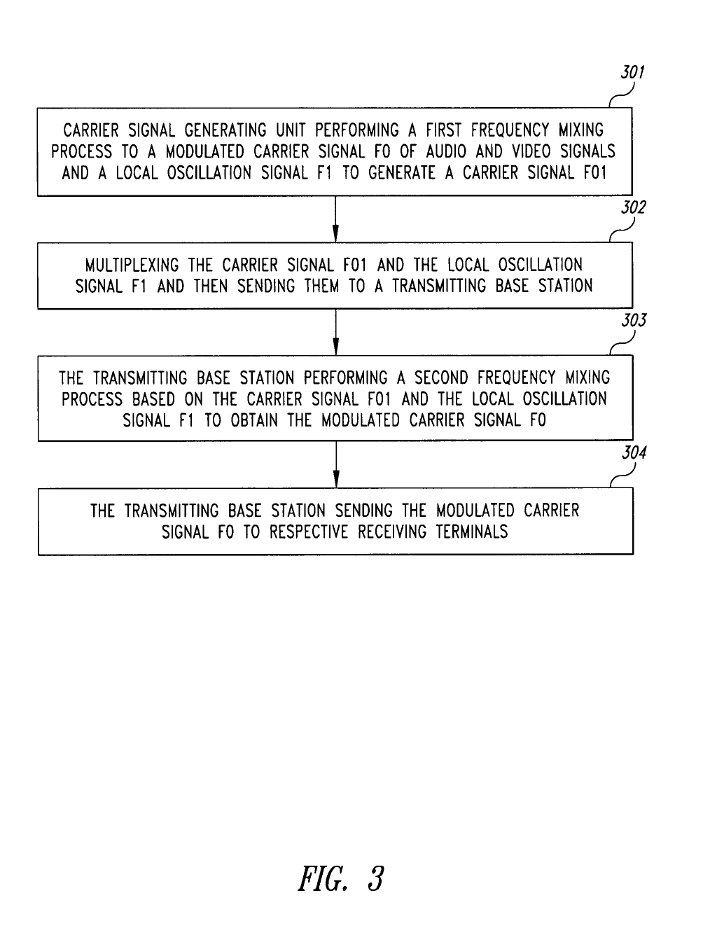

FIG. 3 is a flowchart showing the common-spectrum transmission method for audio and video signals according to one embodiment of the present invention. As shown in FIG. 3, the method comprises:

a step 301 of a carrier signal generating unit performing a first frequency mixing process to a modulated carrier signal f0 of audio and video signals and a local oscillation signal f1 to generate a carrier signal f01;

a step 302 of multiplexing the carrier signal f01 and the local oscillation signal f1 and then sending them to a transmitting base station;

a step 303 of the transmitting base station performing a second frequency mixing process based on the carrier signal f01 and the local oscillation signal f1 to obtain the modulated carrier signal f0;

a step 304 of the transmitting base station sending the modulated carrier signal f0 to respective receiving terminals.

In the step 302 a step of filtering/amplifying the carrier signal f01 and the local oscillation signal f1 is performed before the multiplexing, and then the multiplexed signals are sent to the transmitting base station.

In the step 303 a step of filtering/amplifying the carrier signal f01 and the local oscillation signal f1 is performed after the transmitting base station receives the signal, and then the second frequency mixing process is performed to the carrier signals f01 and the local oscillation signal f1 to obtain the modulated carrier signal f0.

In the step 304, the transmitting base station obtains and filters/amplifies the modulated carrier signal f0 and then transfers it to respective receiving terminals.

The audio and video signals of one embodiment are digital TV signals or broadcasting signals.

The technical scheme of one embodiment of the present invention will be described with an embodiment of digital TV signals.

A modulated digital TV carrier signal f0 which is generated by a carrier signal generating unit and has a frequency of 280 MHz is sent to a frequency mixer to mixed with a local oscillation signal f1 which is generated by a reference clock and has a frequency of 5.6 GHz to generate a link carrier signal f01 which has a frequency of 5.880 GHz. Another local oscillation signal f1 is filtered/amplified and then sent to respective transmitting base stations along with the link carrier signal f01. After the link carrier signal f01 (having a frequency of 5.880 GHz) and the local oscillation signal f1 (having a frequency of 5.6 GHz) are received by respective transmitting base stations, the two signals are filtered/amplified and then sent to a frequency mixer synchronously to be subject to a frequency mixing, by which a modulated carrier signal f0 of digital TV having a frequency of 280 MHz is generated. Finally, the modulated carrier signal f0 is filtered/amplified and then sent to respective receiving terminals.

According to one embodiment of the present invention, since the reference local oscillation signal f1 used by the respective transmitting base stations at the time of performing the frequency mixing comes from one same local oscillation signal source and reaches the frequency mixing unit synchronously with the carrier signal f01, the spectrums of the modulated carrier signal f0 generated by restoration at respective base stations are completely uniform and the common frequency interference generated by respective base stations in the coherent zone can be reduced to minimum.

It should be noted that the embodiments above are only for the illustration of the present invention and not intended to limit the present invention. Therefore, though the present invention has been describe in detail with reference to the embodiments above, it should be understood by those skilled in the art, that any modification or equivalent replacement may be made without departing from the spirit and scope of the present invention that are set forth in the appended claims. Accordingly, the claims are not limited by the disclosure.

The various embodiments described above can be combined to provide further embodiments. All of the foreign patent(s) and/or foreign patent application(s) referred to in this specification and/or listed in the Application Data Sheet, are incorporated herein by reference, in their entirety. Aspects of the embodiments can be modified, if necessary to employ concepts of the various patents, applications and publications to provide yet further embodiments.

What is claimed is:

1. A common-spectrum transmission method for audio and video signals, comprising:
(A) performing a first frequency mixing process to a modulated carrier signal f0 of audio and video signals and a local oscillation signal f1 to generate a carrier signal f01;
(B) multiplexing the carrier signal f01 and the local oscillation signal f1 and then sending them to a transmitting base station;
(C) the transmitting base station performing a second frequency mixing process based on the carrier signal f01 and the local oscillation signal f1 to obtain the modulated carrier signal f0; and
(D) the transmitting base station sending the modulated carrier signal f0 to respective receiving terminals.

2. A common-spectrum transmission method for audio and video signals of claim 1, wherein said (B) further comprises filtering/amplifying the carrier signal f01 and the local oscillation signal f1.

3. A common-spectrum transmission method for audio and video signals of claim 1, wherein said (C) further comprises filtering/amplifying the carrier signal f01 and the local oscillation signal f1.

4. A common-spectrum transmission method for audio and video signals of claim 1, wherein in said (D), the transmitting base station filters/amplifies the modulated carrier signal f0 and then sends it to respective receiving terminals.

5. A common-spectrum transmission method for audio and video signals of claim 1, wherein the audio and video signals are digital TV signals or broadcasting signals.

6. A common-spectrum transmission system for audio and video signals, comprising:
a carrier signal generating unit and a plurality of transmitting base stations, wherein:
the carrier signal generating unit includes:
a modulating unit to modulate the audio and video signals as a carrier signal f0;
a local oscillation unit to generate a local oscillation signal f1;
a first frequency mixing unit to mix the carrier signal f0 and the local oscillation signal f1 to generate a carrier signal f01; and
a multiplexing unit to multiplex the carrier signal f01 and the local oscillation signal f1 and then to send them to the transmitting base stations,
the transmitting base station includes:
a second frequency mixing unit to perform a frequency mixing process based on the carrier signal f01 and the local oscillation signal f1 to obtain the carrier signal f0; and
a transmitting unit to send the carrier signal f0 to a receiving terminal.

7. A common-spectrum transmission system for audio and video signals of claim 6, wherein the carrier signal generating unit further comprises a first filtering/amplifying unit to filter/amplify the carrier signal f01 outputted from the first frequency mixing unit and/or the local oscillation signal f1 outputted from the local oscillation unit.

8. A common-spectrum transmission system for audio and video signals of claim 6, wherein the transmitting base station further comprises a second filtering/amplifying unit to receive the signal sent by the carrier signal generating unit and to filter/amplify the received signal to obtain the carrier signal f01 and/or the local oscillation signal f1.

9. A common-spectrum transmission system for audio and video signals of claim 6, wherein the transmitting base station further comprises a third filtering/amplifying unit coupled to the second frequency mixing unit to filter/amplify the carrier signal f0 outputted from the second frequency mixing unit and then to send it to the transmitting unit.

10. A common-spectrum transmission system for audio and video signals, the system comprising:
means for performing a first frequency mixing process to a modulated carrier signal f0 of audio and video signals and a local oscillation signal f1 to generate a carrier signal f01;
means for multiplexing the carrier signal f01 and the local oscillation signal f1 and then for sending them to a transmitting base station;
means at the transmitting base station for performing a second frequency mixing process based on the carrier signal f01 and the local oscillation signal f1 to obtain the modulated carrier signal f0; and
means at the transmitting base station for sending the modulated carrier signal f0 to respective receiving terminals.

11. The system of claim 10 wherein said means for performing said first frequency mixing process is part of a carrier signal generating unit that includes:
a modulation unit to receive said audio and video signals and to generate said modulated carrier signal f0;
a reference clock unit coupled to a local oscillation unit to generate said local oscillation signal f1; and
a first frequency mixing unit coupled to said modulation unit to receive said generated modulated carrier signal f0 and coupled to said local oscillation unit to receive said generated local oscillation signal f1, and to mix said generated modulated carrier signal f0 and said generated local oscillation signal f1 to generate said carrier signal f01.

12. The system of claim 11 wherein said means for multiplexing the carrier signal f01 and the local oscillation signal f1 and then for sending them are also part of said carrier signal generating unit that includes:
a first filtering/amplifying unit coupled to said first frequency mixing unit to filter/amplify said carrier signal f01, and coupled to said local oscillation unit to filter/amplify said local oscillation signal f1; and
a multiplexing unit coupled to said first filtering/amplifying unit to receive and to multiplex said filtered/amplified carrier signal f01 and local oscillation signal f1.

13. The system of claim 10 wherein said means at the transmitting base station for performing said second frequency mixing includes:
a second filtering/amplifying unit to receive and to filter/amplify said multiplexed carrier signal f01 and local oscillation signal f1 sent by said means for sending; and
a second frequency mixing unit coupled to said second filtering/amplifying to receive said filtered/amplified carrier signal f01 and local oscillation signal f1, and to mix the carrier signal f01 and the local oscillation signal f1 to obtain the carrier signal f0.

14. The system of claim 13 wherein said means at the transmitting base station for sending said modulated carrier signal f0 includes:
a third filtering/amplifying unit coupled to said second frequency mixing unit to receive and to filter/amplify said carrier signal f0 obtained by the second frequency mixing unit;
a transmitting unit coupled to said third filtering/amplifying unit to send said filtered/amplified carrier signal f0 to a receiving terminal.

15. The system of claim 10 wherein said audio and video signals are digital TV signals or broadcasting signals.
